(19) United States
(12) Patent Application Publication
(10) Pub. No.: US 2023/0344100 A1
(43) Pub. Date: Oct. 26, 2023

(54) PHASE SHIFTER

(71) Applicant: KMW INC., Hwaseong-si (KR)

(72) Inventors: Young Chan MOON, Suwon-si (KR); Sung Hwan SO, Hwaseong-si (KR); Oh Seog CHOI, Hwaseong-si (KR); Seong Man KANG, Hwaseong-si (KR); Hun Jung JUNG, Hwaseong-si (KR); Yong Won SEO, Hwaseong-si (KR); Gyo Jin JO, Yongin-si (KR)

(73) Assignee: KMW INC., Hwaseong-si (KR)

(21) Appl. No.: 18/215,894

(22) Filed: Jun. 29, 2023

Related U.S. Application Data
(63) Continuation of application No. PCT/KR2021/019472, filed on Dec. 21, 2021.

(30) Foreign Application Priority Data
Jan. 11, 2021 (KR) 10-2021-0003014

(51) Int. Cl. H01P 1/18; H01Q 3/32

(52) U.S. Cl. CPC H01P 1/182; H01Q 3/32

(57) ABSTRACT

According to an embodiment of the present disclosure, a phase shifter comprising: a fixed unit including a base and a first fixed board disposed on one surface of the base; a first moving unit movable along a first direction on one surface of the first fixed board, the first moving unit including a first moving board facing the first fixed board; and a guide bracket fixed to one side of the fixed unit, the guide bracket configured to guide movement of the first moving unit along a first direction.

### CROSS-REFERENCE TO RELATED APPLICATION(S)

This application is a continuation application of International Application No. PCT/KR2021/019472, filed on Dec. 21, 2021, which claims priority to Patent Application No. 10-2021-0003014, filed on Jan. 11, 2021 in South Korea, the entire contents of which are incorporated herein by reference.

### TECHNICAL FIELD

The present disclosure relates to a phase shifter.

### BACKGROUND ART

The description in this document simply provides background information for the present disclosure and does not constitute the prior art.

An antenna device achieves the most extensive coverage by forming beams in the horizontal direction; in some cases, however, the beam angle needs to be adjusted in the vertical direction to cope with interference or beam loss. In this case, the antenna device adjusts the beam angle in the vertical direction through a mechanical or electrical beam tilting method.

The mechanical beam tilting method adjusts the beam angle by directly installing the antenna device downward. Although it is a simple method, the mechanical beam tilting method is somewhat cumbersome for various reasons, such as a worker's absence from visiting another site and a power cut-off during work.

The electrical beam tilting method is based on a multi-line phase shifter (MLPS). Specifically, the electrical beam tilting method adjusts the beam angle by feeding signals having different phases to a plurality of vertically arranged radiating elements.

An antenna device may employ a phase shifter to implement the electrical beam tilting method. The phase shifter appropriately delays an input signal to generate a phase difference between the input and output signals. In this case, the input signal may be delayed by changing the length of a transmission line or changing the signal propagation speed in the transmission line.

The patent publication No. 2010-0122005 (in what follows, patent document 1), which is related to a conventional phase shifter, discloses a fixed board with one input port and a plurality of output ports and a moving board with a variable strip. However, patent document 1 has a disadvantage because the disclosed phase shifter is not space efficient since the fixed and moving boards are provided only on one side of the phase shifter.

Recently, multi-band frequency antenna devices capable of supporting various bands have been widely used as a base station or repeater of a mobile communication system. A multi-band antenna device needs to adjust the phases of several frequency bands individually.

Accordingly, the number of phase shifters included in the antenna device may increase, demanding the phase shifter to be further reduced in size and weight.

### PRIOR ART REFERENCES

(Patent document 1) Patent publication No. 2010-0122005 (laid-open on Nov. 19, 2010)

### DISCLOSURE

### Technical Problem

Accordingly, an object of the present disclosure is to provide a miniaturized, lightweight phase shifter having a simple structure.

Also, an object of the present disclosure is to design a phase shifter with a plurality of moving strips formed on a sub-board of a moving board and reduce the size of a fixed board, thereby lowering the manufacturing cost.

Also, an object of the present disclosure is to improve space utilization of an antenna device by reducing the installation space of a phase shifter within the inner space of the antenna device.

Also, an object of the present disclosure is to provide a phase shifter that may be easily repaired and reassembled.

### Technical Solution

According to an embodiment of the present disclosure, a phase shifter comprising: a fixed unit including a base and a first fixed board disposed on one surface of the base; a first moving unit movable along a first direction on one surface of the first fixed board, the first moving unit including a first moving board facing the first fixed board; and a guide bracket fixed to one side of the fixed unit, the guide bracket configured to guide movement of the first moving unit along a first direction.

### Advantageous Effects

A phase shifter according to the present embodiment described above may be miniaturized and made lightweight, thereby enabling a space-efficient design of an antenna device and reducing the manufacturing cost.

### DESCRIPTION OF DRAWINGS

FIG. 1 is a perspective view of a phase shifter according to one embodiment of the present disclosure.

FIGS. 2 and 3 are exploded perspective views of a phase shifter according to one embodiment of the present disclosure.

FIG. 4 illustrates adjusting a phase difference between signals transmitted through individual transmission lines due to movement of a first moving unit by a phase shifter according to one embodiment of the present disclosure.

FIG. 5 is a cross-sectional view of a phase shifter according to one embodiment of the present disclosure, cut along the V-V′ direction of FIG. 1.

FIGS. 6A and 6B are perspective views of a guide bracket according to one embodiment of the present disclosure.

FIG. 7 is a perspective view of a first moving unit according to a second embodiment of the present disclosure.

FIG. 8 is a perspective view of a first moving unit according to a third embodiment of the present disclosure.

FIG. 9 is a perspective view of a first moving unit according to a fourth embodiment of the present disclosure.

FIGS. 10A, 10B and 10C are perspective views of a first moving unit according to a fifth embodiment of the present disclosure.

### MODE FOR DISCLOSURE

Hereinafter, some embodiments of the present disclosure will be described in detail with reference to the accompanying illustrative drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

Additionally, various ordinal numbers or alpha codes such as first, second, i), ii), a), b), etc., are prefixed solely to differentiate one component from the other but not to imply or suggest the substances, order, or sequence of the components. Throughout this specification, when a part “includes” or “comprises” a component, the part is meant to further include other components, not to exclude thereof unless specifically stated to the contrary.

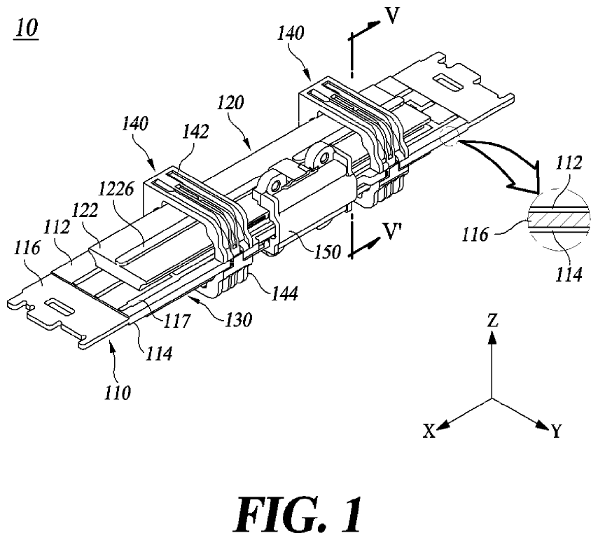

FIG. 1 is a perspective view of a phase shifter 10 according to one embodiment of the present disclosure.

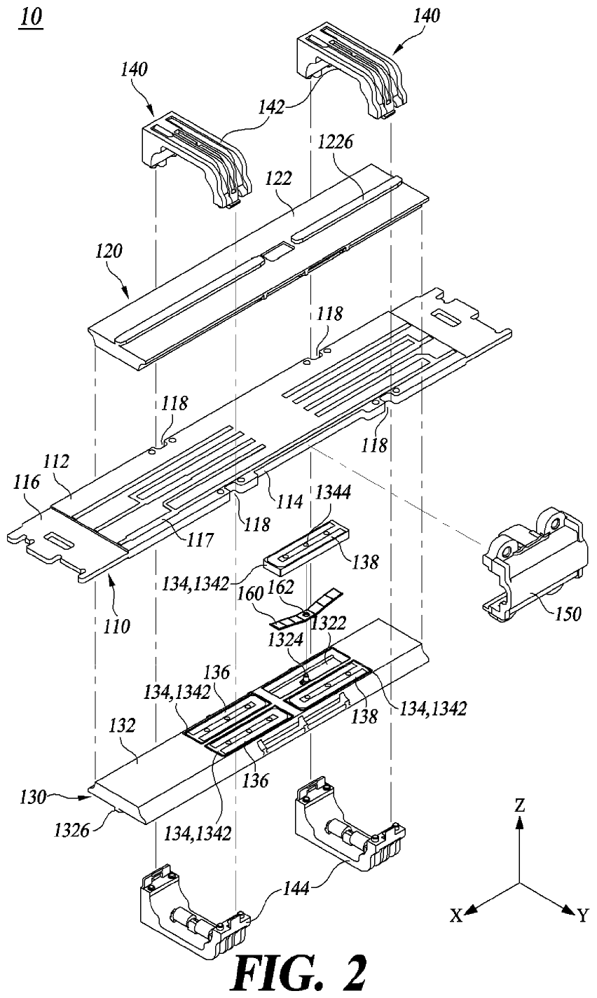

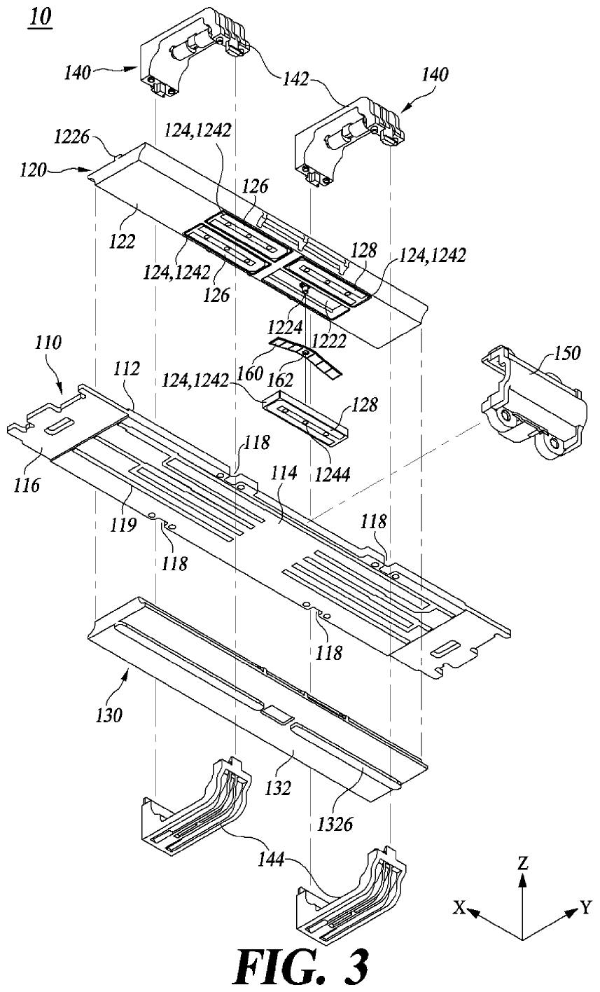

FIGS. 2 and 3 are exploded perspective views of a phase shifter 10 according to one embodiment of the present disclosure.

Referring to FIGS. 1 to 3, the phase shifter 10 may comprise a fixed unit 110, a first moving unit 120, a second moving unit 130, and a guide bracket 140.

The fixed unit 110 may include a first fixed board 112, a second fixed board 114, and a base 116.

The first fixed board 112 may be disposed on one surface of the base 116, and the second fixed board 114 may be disposed on the other surface of the base 116.

Circuit patterns 117, 119 may be formed on the first fixed board 112 and the second fixed board 114, respectively. The circuit patterns 117, 119 formed on the fixed boards 112, 114 may be electrically coupled with moving strips of the corresponding moving boards 124, 126.

Each circuit pattern 117, 119 may be connected to at least one input port and a plurality of output ports. Each circuit pattern 117, 119 may share at least one input port with others, or each circuit pattern 117, 119 may have one input port.

The circuit patterns 117, 119 of the fixed boards 112, 114 may be coupled with moving strips of the corresponding moving boards 124, 134 to form a plurality of transmission lines.

A signal received through an input port may be passed to each output port through the corresponding transmission line. The signal transmitted to each output port may be transmitted to the corresponding antenna element (not shown) through an RF cable or an RF connector.

When the moving boards 124, 134 move relative to the fixed boards 112, 114, the moving strips also move relative to the respective circuit patterns 117, 119. Through the above mechanism, it is possible to shorten or extend the length of each transmission line, which accordingly adjusts a phase difference between signals transmitted through the respective transmission lines.

The base 116 may be disposed between the first fixed board 112 and the second fixed board 114. The base 116 may be constructed using Teflon material, exhibiting a low loss rate in the high-frequency environment. However, the present disclosure is not limited to the specific material, and the base 116 may be fabricated using materials different from the Teflon material.

The first moving unit 120 is configured to move along a first direction on one surface of the first fixed board 112. Here, the first direction is parallel to the longitudinal direction of the phase shifter 10. For example, by referring to FIGS. 1 to 3, the first direction is parallel to the X-axis.

The first moving unit 120 may include a first moving body 122 and a first moving board 124.

The first moving body 122 may form the outer shape of the first moving unit 120, and the first moving board 124 may be disposed on one surface of the first moving body 122 facing the first fixed board 112. In this case, the first moving board 124 may face the first fixed board 112.

The first moving board 124 may include a plurality of first moving strips 126 and a plurality of second moving strips 128.

The plurality of first moving strips 126 may be disposed side by side along a second direction perpendicular to the first direction, and the plurality of second moving strips 128 may be disposed side by side along the second direction. Here, the second direction is parallel to the transverse direction of the phase shifter 10. For example, based on FIGS. 1 to 3, the second direction is parallel to the Y-axis.

Since the plurality of moving strips are disposed side by side along the second direction, the plurality of first moving strips 126 and the plurality of second moving strips 128 form a strip row, respectively. Here, the strip row refers to a plurality of moving strips disposed side by side along the second direction.

Also, the plurality of first moving strips 126 and the plurality of second moving strips 128 may be disposed side by side along the first direction. In this case, one first moving strip 126 and one second moving strip 128 adjacent thereto may form a strip column. Here, the strip column refers to a plurality of moving strips disposed side by side in the first direction.

Here, the number of strip columns may be the same as the number of first moving strips 126 or the number of second moving strips 128. For example, if the number of first moving strips 126 or second moving strips 128 is two, the number of strip columns may be two.

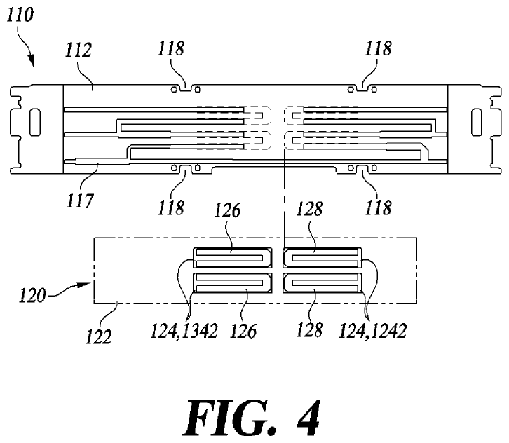

The phase shifter 10 according to one embodiment of the present disclosure may form a plurality of strip columns on the moving boards 124, 134, through which the sizes of the moving boards 124, 134 and the fixed boards 112, 114 may be reduced. As a result, the phase shifter 10 may be miniaturized or made lightweight. Detailed descriptions of the aspect above will be given with respect to FIG. 4.

Meanwhile, although FIGS. 1 to 3 assume that two strip rows and two strip columns are formed on the first moving board 124, the present disclosure is not limited to the specific assumption. For example, three or more strip rows or three or more strip columns may be formed on the first moving board 124.

The first moving body 122 and the first moving board 124 may move along the first direction on one surface of the first fixed board 112. Here, the first moving strip 126 and the second moving strip 128 formed on the first moving board 124 may also move along the first direction.

Through the mechanism above, it is possible to shorten or extend the length of each transmission line, through which the phase difference between signals transmitted through the respective transmission lines may be adjusted.

The first moving board 124 according to one embodiment of the present disclosure may include a plurality of sub-boards 1242.

Each moving strip of the plurality of first moving strips 126 and the plurality of second moving strips 128 may be formed on each sub-board 1242 of the plurality of sub-boards 1242.

In other words, one moving strip may be formed on one sub-board 1242.

Each sub-board 1242 may be seated in each receiving groove 1222 of a plurality of receiving grooves 1222 formed on one surface of the first moving body 122.

Here, a leaf spring 160 may be first seated into the receiving groove 1222, and then the sub-board 1242 may be seated.

Since each receiving groove 1222 accommodates one leaf spring 160 and one sub-board 1242, each sub-board 1242 may be individually pressed by the corresponding leaf spring 160. Accordingly, the contact between the first fixed board 112 and the first moving board 124 may be improved.

A mounting protrusion 1224 may be formed inside the receiving groove 1222, and through-holes 1244, 162, through which the mounting protrusion 1224 may pass, may be formed on the sub-board 1242 and the leaf spring 160.

When the sub-board 1242 and the leaf spring 160 are seated in the receiving groove 1222, the mounting protrusion 1224 may pass through the through-holes 1244, 162, which aligns the sub-board 1242 and the leaf spring 160 within the receiving groove 1222.

The second moving unit 130 may be disposed on the opposite side of the first moving unit 120 with respect to the fixed unit 110.

The second moving unit 130 is configured to move along the first direction on one surface of the second fixed board 114. Here, the second moving unit 130 may move separately from the first moving unit 120 or may move together in conjunction with the first moving unit 120.

The second moving unit 130 may include a second moving body 132 and a second moving board 134.

The second moving body 132 may form the outer shape of the second moving unit 130, and the second moving board 134 may be disposed on one surface of the second moving body 132 facing the second fixed board 114. In this case, the second moving board 134 may face the second fixed board 114.

The second moving board 134 may include a plurality of third moving strips 136 and a plurality of fourth moving strips 138.

The plurality of third moving strips 136 may be disposed side by side along the second direction, and the plurality of fourth moving strips 138 may be disposed side by side along the second direction. Here, the plurality of third moving strips 136 and the plurality of fourth moving strips 138 form a strip row, respectively.

Also, the plurality of third moving strips 136 and the plurality of fourth moving strips 138 may be disposed side by side along the first direction.

In this case, one fourth moving strip 138 and one third moving strip 136 adjacent thereto may form a strip column. Here, the number of strip columns may be the same as the number of third moving strips 136 or the number of fourth moving strips 138.

Meanwhile, although FIGS. 1 to 3 assume that two strip rows and two strip columns are formed on the second moving board 134, the present disclosure is not limited to the specific assumption. For example, three or more strip rows or three or more strip columns may be formed on the second moving board 134.

The second moving body 132 and the second moving board 134 may move along the first direction on one surface of the second fixed board 114. Here, the third moving strip 136 and the fourth moving strip 138 formed on the second moving board 134 may also move along the first direction.

Through the mechanism above, it is possible to shorten or extend the length of each transmission line, through which the phase difference between signals transmitted through the respective transmission lines may be adjusted.

The second moving board 134 may include a plurality of sub-boards 1342.

Each moving strip of the plurality of third moving strips 136 and the plurality of fourth moving strips 138 may be formed on each sub-board 1342 of the plurality of sub-boards 1342. In other words, one moving strip may be formed on one sub-board 1342.

Each sub-board 1342 may be individually pressed by the corresponding leaf spring 160. Accordingly, the contact between the second fixed board 112 and the second moving board 124 may be improved.

A technical feature of the phase shifter 10 according to one embodiment of the present disclosure lies in that the phase shifter 10 controls the phase of a signal at both sides of the phase shifter 10 by disposing the first moving unit 120 and the second moving unit 130 on both sides of the fixed unit 110. The feature above may make the phase shifter 10 more compact and lightweight.

The guide bracket 140 may guide the movement of the first moving unit 120 in the first direction and the movement of the second moving unit 130 in the first direction, respectively.

The guide bracket 140 may be fixed to one side of the fixed unit 110, for example, to the coupling groove 118 of the fixed unit 110. The guide bracket 140 may enclose the fixed unit 110 and the moving units 120, 130 while being fixed to the fixed unit 110.

Through the above structure, the guide bracket 140 may restrict the movement direction of the moving units 120, 130 to the first direction and prevent the moving units 120, 130 from moving in a direction other than the first direction.

On the other hand, since the guide bracket 140 restricts the movement direction of the moving units 120, 130 to the first direction, the contact between the fixed board 112, 114 and the moving board 124, 134 may be maintained securely.

However, the binding force of the guide bracket 140 may act differently depending on the position of the moving units 120, 130. For example, a relatively smaller binding force may act on a portion of the moving units 120, 130 distant from the guide bracket 140 than a portion of the moving units 120, 130 adjacent to the guide bracket 140.

The portion of the moving units 120, 130 which receives a small binding force may be lifted from the fixed unit 110. In this case, the contact between the moving unit 120, 130 and the fixed unit 110 may be weakened.

To prevent the contact from being weakened, the phase shifter 10 may include a plurality of guide brackets 140 disposed along the first direction. The plurality of guide brackets 140 may restrain the moving units 120, 130 at more points, thereby minimizing the lifting problem of the moving units 120, 130.

Meanwhile, since a plurality of strip columns are formed on the moving boards 124, 134, the number of strip rows formed on the moving boards 124, 134 may be reduced proportionally. In this case, as the overall size of the moving boards 124, 134 in the first direction decreases, the size of the moving units 120, 130 in the first direction may also decrease.

Therefore, the phase shifter 10 according to one embodiment of the present disclosure may provide a sufficient binding force to the moving units 120, 130 even when a relatively small number of guide brackets 140 are employed.

The phase shifter 10 may additionally include a holder 150 and a leaf spring 160.

The holder 150 may fix the phase shifter 10 to another external member.

One side of the holder 150 may be connected to the fixed unit 110, and the other side of the holder 150 may be connected to another external member.

The holder 150 may enclose at least part of the peripheries of the fixed unit 110 and the moving units 120, 130. Through the above structure, the holder 150 may guide the movement of the moving units 120, 130 in the first direction together with the guide bracket 140.

The leaf spring 160 may be disposed on one side of the first moving unit 120 and one side of the second moving unit 130. For example, the leaf spring 160 may be seated into the receiving grooves 1222, 1322 formed in the moving bodies 122, 132.

The leaf spring 160 may be configured to press the moving boards 124, 134 toward the fixed boards 112, 114.

Although FIGS. 1 to 3 assume that the first moving unit 120 is disposed in the upper part of the fixed unit 110 and the second moving unit 130 is disposed in the lower part of the fixed unit 110, the present disclosure is not limited to the specific assumption.

For example, the first moving unit 120 may be disposed in the lower part of the fixed unit 110, and the second moving unit 130 may be disposed in the upper part of the fixed unit 110. In this case, the first fixed board 112 may be disposed on the lower surface of the base 116, and the second fixed board 114 may be disposed on the upper surface of the base 116.

FIG. 4 illustrates adjusting a phase difference between signals transmitted through individual transmission lines due to movement of a first moving unit 120 by a phase shifter 10 according to one embodiment of the present disclosure.

Referring to FIG. 4, the first moving board 124 may move along the first direction on one surface of the first fixed board 112. Here, the first moving strip 126 and the second moving strip 128 disposed on the first moving board 124 may also move along the first direction. Through the mechanism above, it is possible to shorten or extend the length of each transmission line, through which the phase difference between signals transmitted through the respective transmission lines may be adjusted.

The first moving strip 126 and the second moving strip 128 may have a convex shape, for example, a “U” shape.

For example, each first moving strip 126 of a plurality of first moving strips 126 may have a convex shape toward a neighboring second moving strip 128, and each second moving strip 128 of a plurality of second moving strips 128 may have a convex shape toward a neighboring first moving strip 126.

When the first moving strip 126 and the second moving strip 128 have a convex shape with respect to each other, the shape of the circuit pattern 117 of the first fixed board 112 may be further simplified compared to the case in which the first moving strip 126 and the second moving strip 128 have a concave shape with respect to each other or have a convex shape toward the same direction.

Specifically, with reference to FIG. 4, the portion of the circuit pattern 117 coupled with the first moving strip 126 may be disposed on the left side of the first moving strip 126, and the portion of the circuit pattern 117 coupled with the second moving strip 128 may be disposed on the right side of the second moving strip 128. In other words, the portion of the circuit pattern 117 coupled with the first moving strip 126 and the portion of the circuit pattern 117 coupled with the second moving strip 128 may be separated from each other.

In this case, the shape of the circuit pattern 117 of the first fixed board 112 may be simplified further because a complex design of the circuit pattern 117 is not required to prevent the portions of the circuit pattern 117 from overlapping with each other.

On the other hand, when another moving strip (in what follows, “an additional moving strip”) is present in the left area of the first moving strip 126, and the first moving board 124 moves in the right direction along the first direction, the additional moving strip may overlap a portion of the circuit pattern 117 coupled with the first moving strip 126.

Therefore, to avoid the overlapping issue of the additional moving strip and, at the same time, to secure a sufficient movement space for the first moving board 124, the additional moving strip needs to be spaced apart from the first moving strip 126 in the first direction.

As the distance between moving strips increases, the area on the first fixed board 112, not having the circuit pattern 117, may increase, and the overall size of the first fixed board 112 may grow accordingly.

Since the phase shifter 10 according to one embodiment of the present disclosure is configured so that a plurality of strip columns are formed on the first moving board 124, the number of strip rows formed on the first moving board 124 may be reduced.

For example, the plurality of first moving boards 124 may include a plurality of first moving strips 126 and a plurality of second moving strips 128 and may not include other moving strips.

In other words, with reference to FIG. 4, moving strips may not exist in the left area of the first moving strip 126 and in the right area of the second moving strip 128. In this case, only two strip rows may be formed on the first moving board 124.

Accordingly, the area on the first fixed board 112 in which the circuit pattern 117 is not formed, namely, the area for securing a movement space of the first moving board 124 may be reduced. Through the structure above, the first fixed board 112 may have a more compact shape, which may in turn lower the manufacturing cost of the first fixed board 112.

However, the present disclosure is not limited to the description above, and the number of strip rows formed on the first moving board 124 may be set differently according to the number of arranged antenna elements. For example, three or more strip rows may be formed on the moving boards 124, 134 according to one embodiment of the present disclosure.

Meanwhile, signal transmission may be performed through a combination of a PCB circuit pattern and an RF cable, where signal loss may be more pronounced in the PCB circuit pattern compared to the RF cable.

When the size of the first fixed board 112 is reduced, the area occupied by the PCB circuit pattern may be proportionally decreased, while conversely, the area occupied by the RF cable may be relatively increased. As a result, the signal loss generated in the phase shifter 10 may be reduced.

Although FIG. 4 illustrates the first fixed board 112 and the first moving unit 120 as an example, the above description is not limited only to the first fixed board 112 and the first moving unit 120. Accordingly, the description given with reference to FIG. 4 may also be applied to the second fixed board 114 and the second moving unit 130 without modification.

For example, each third moving strip 136 of a plurality of third moving strips 136 may have a convex shape toward a neighboring fourth moving strip 138, and each fourth moving strip 138 of a plurality of fourth moving strips 138 may have a convex shape toward a neighboring third moving strip 136. Therefore, the shape of the circuit pattern 119 of the second fixed board 114 may be further simplified.

Also, the second moving board 134 may include a plurality of third moving strips 136 and a plurality of fourth moving strips 138 and may not include other moving strips. As a result, the size of the second fixed board 114 may be reduced. Accordingly, the manufacturing cost of the second fixed board 114 may be reduced, and the overall signal loss may also be reduced.

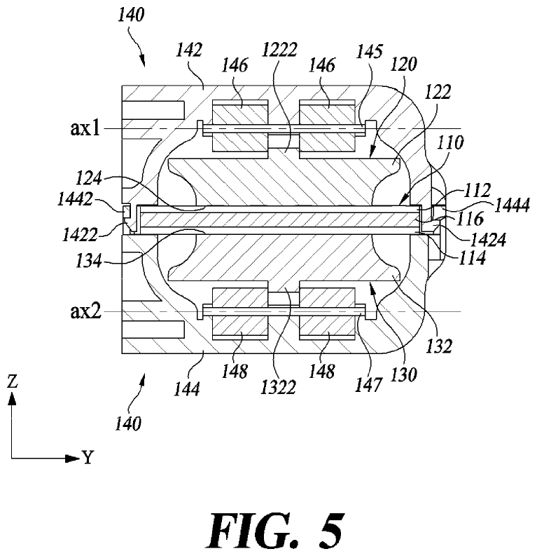

FIG. 5 is a cross-sectional view of a phase shifter 10 according to one embodiment of the present disclosure, cut along the V-V′ direction of FIG. 1.

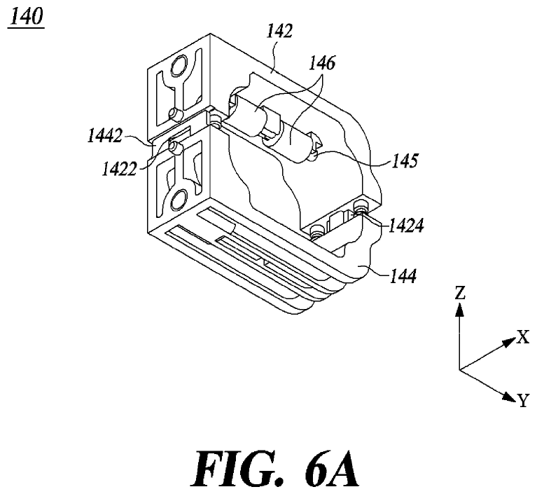

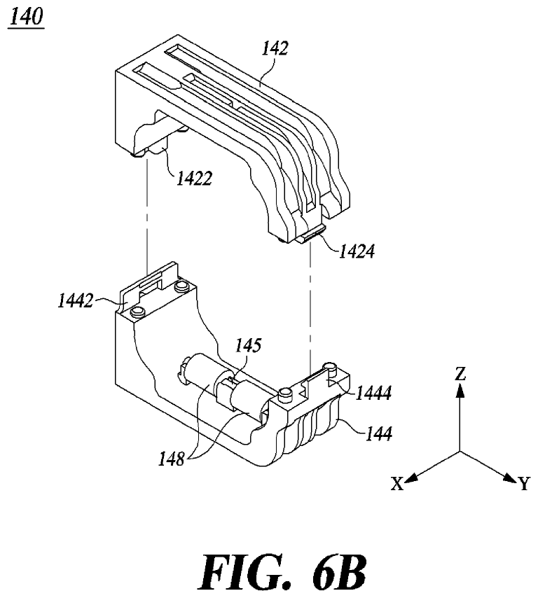

FIGS. 6A and 6B are perspective views of a guide bracket 140 according to one embodiment of the present disclosure. Specifically, FIG. 6A illustrates a guide bracket 140 in the assembled state, while FIG. 6B illustrates a guide bracket 140 in the disassembled state.

Referring to FIGS. 5, 6A and 6B, the guide bracket 140 may include a first segment 142, a second segment 144, a first shaft member 145, a first roller 146, a second shaft member 147, and a second roller 148.

The first segment 142 may be disposed in the upper part of the fixed unit 110 and have a shape surrounding the first moving unit 120. The second segment 144 may be disposed in the lower part of the fixed unit 110 and have a shape surrounding the second moving unit 130. The first segment 142 and the second segment 144 may be coupled to each other.

While the first segment 142 and the second segment 144 are coupled to each other, the guide bracket 140 may fully enclose the fixed unit 110, the first moving unit 120, and the second moving unit 130.

Through the above structure, the guide bracket 140 may restrict the movement direction of the moving units 120, 130 to the first direction and prevent the moving units 120, 130 from moving in a direction other than the first direction.

The first segment 142 may include a first coupling unit 1422 and a second coupling unit 1424, and the second segment 144 may include a third coupling unit 1442 and a fourth coupling unit 1444.

The first coupling unit 1422 may be formed on one side of the first segment 142, and the second coupling unit 1424 may be formed on the other side of the first segment 142. Also, the third coupling unit 1442 may be formed on one side of the second segment 144, and the fourth coupling unit 1444 may be formed on the other side of the second segment 144.

The first coupling unit 1422 may be disposed at a position corresponding to the third coupling unit 1442, and the first coupling unit 1422 and the third coupling unit 1442 may be coupled to each other.

For example, the first coupling unit 1422 and the third coupling unit 1442 may be coupled to each other through a hook coupling method. In this case, one of the first coupling unit 1422 and the third coupling unit 1442 may include a hook, and the other one of the first coupling unit 1422 and the third coupling unit 1442 may include a catching groove or a catching hole into which the hook may be coupled.

The second coupling unit 1424 may be disposed at a position corresponding to the fourth coupling unit 1444, and the second coupling unit 1424 and the fourth coupling unit 1444 may be coupled to each other.

For example, the second coupling unit 1424 and the fourth coupling unit 1444 may be coupled to each other through a hook coupling method. In this case, one of the second coupling unit 1424 and the fourth coupling unit 1444 may include a hook, and the other one of the second coupling unit 1424 and the fourth coupling unit 1444 may include a catching groove or a catching hole into which the hook may be coupled.

The first shaft member 145 and the second shaft member 147 may be shaft-shaped members elongated in the second direction.

The first shaft member 145 may be disposed on the first segment 142 and may be disposed in the upper part of the first moving unit 120.

The first roller 146 may be connected to the first shaft member 145 and may contact or face the upper surface of the first moving body 122.

The first roller 146 is configured to rotate about the first rotation axis ax1. Here, the first rotation axis ax1 refers to a virtual axis of rotation being parallel to the second direction and passing through the center of the first shaft member 145.

The rotation method may be performed such that only the first roller 146 rotates while the first shaft member 145 is fixed to the first segment 142; however, the present disclosure is not limited to the specific rotation scheme. For example, while the first shaft member 145 is fixed to the first roller 146, the first roller 146 and the first shaft member 145 rotate together.

The guide bracket 140 may include a pair of first rollers 146. The pair of first rollers 146 may be spaced apart from each other on the first shaft member 145 in the second direction.

In this case, the first guide rib 1226 protruding from the upper surface of the first moving body 122 may be disposed between the pair of first rollers 146, and both side surfaces of the first guide rib 1226 in the second direction may be supported by the pair of first rollers 146. Through the structure above, the movement of the first moving unit 120 in the second direction may be prevented, thereby preventing the position of the first moving unit 120 from being distorted in the second direction.

The second shaft member 147 may be disposed on the second segment 144 and may be disposed in the lower part of the second moving unit 130.

The second roller 148 may be connected to the second shaft member 147 and may contact or face the lower surface of the second moving body 132. Also, the second roller 148 is configured to rotate around the second rotation axis ax2. Here, the second rotation axis ax2 refers to a virtual axis of rotation that is parallel to the second direction and passes through the center of the second shaft member 147.

The rotation method may be performed such that only the second roller 148 rotates while the second shaft member 147 is fixed to the second segment 144; however, the present disclosure is not limited to the specific rotation method. For example, while the second shaft member 147 is fixed to the second roller 148, the second roller 148 and the second shaft member 147 rotate together.

The guide bracket 140 may include a pair of second rollers 148. The pair of second rollers 148 may be spaced apart from each other on the second shaft member 147 in the second direction.

In this case, the second guide rib 1326 protruding from the lower surface of the second moving body 132 may be disposed between the pair of second rollers 148, and both side surfaces of the second guide rib 1326 in the second direction may be supported by the pair of second rollers 148. Through the structure above, the movement of the second moving unit 130 in the second direction may be prevented, thereby preventing the position of the second moving unit 130 from being distorted in the second direction.

Although FIGS. 5, 6A and 6B assume that the first segment 142 is disposed in the upper part of the fixed unit 110 and the second segment 144 is disposed in the lower part of the fixed unit 110, the present disclosure is not limited to the specific assumption.

For example, the first segment 142 may be disposed in the lower part of the fixed unit 110, and the second segment 144 may be disposed in the upper part of the fixed unit 110. In this case, the first moving unit 120 may be disposed in the lower part of the fixed unit 110, and the second moving unit 130 may be disposed in the upper part of the fixed unit 110.

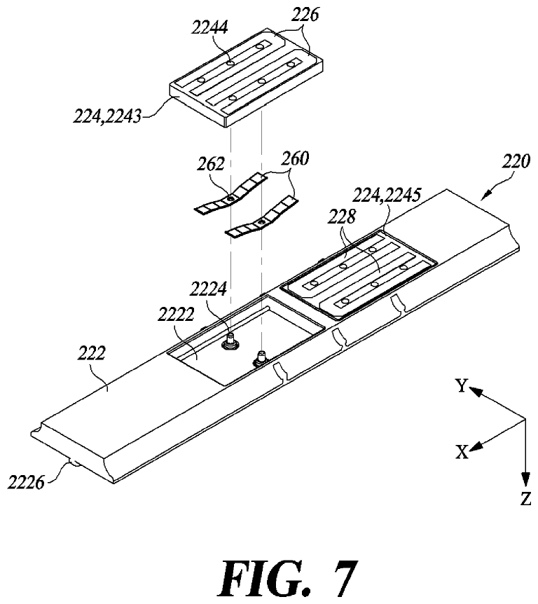

The second to fourth embodiments of the present disclosure shown in FIGS. 7 to 9 to be described later differ from one embodiment of the present disclosure shown in FIGS. 1 to 6 in that a plurality of moving strips are formed on a sub-board. In what follows, distinctive characteristics of the respective embodiments of the present disclosure will be mainly described, and repeated descriptions of substantially the same configuration as one embodiment of the present disclosure will be omitted.

FIG. 7 is a perspective view of a first moving unit 220 according to a second embodiment of the present disclosure.

Referring to FIG. 7, the first moving unit 220 may include a first moving body 222 and a first moving board 224.

The first moving board 224 may include a first sub-board 2243 and a second sub-board 2245 separated from the first sub-board 2243 in the first direction.

A plurality of first moving strips 226 may be formed on the first sub-board 2243, and a plurality of second moving strips 228 may be formed on the second sub-board 2245. In other words, a plurality of moving strips constituting one strip row may be disposed on one sub-board 2243, 2245.

Each sub-board 2243, 2245 may be seated into each receiving groove 2222 of a plurality of receiving grooves 2222 formed on one surface of the first moving body 222. Here, two leaf springs 260 may be first seated into the receiving groove 2222, and then the sub-board 2243, 2245 may be seated.

Since each receiving groove 2222 accommodates two leaf springs 260 and one sub-board 2243, 2245, each sub-board 2243, 2245 may be pressed by the corresponding two leaf springs 260.

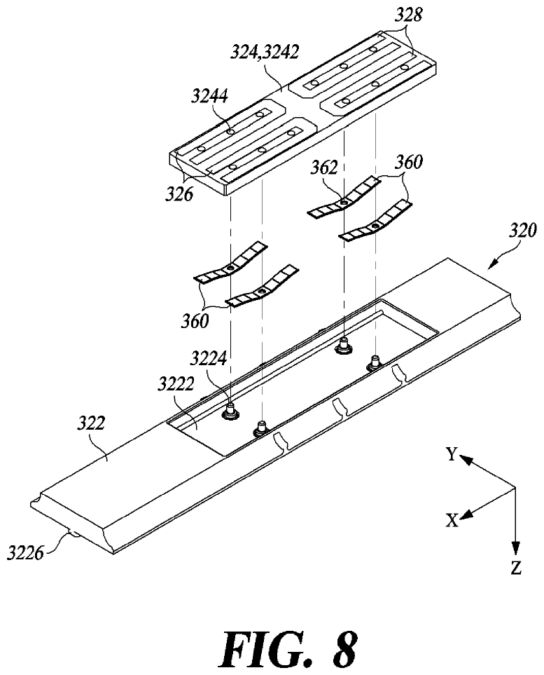

FIG. 8 is a perspective view of a first moving unit 320 according to a third embodiment of the present disclosure.

Referring to FIG. 8, the first moving unit 320 may include a first moving body 322 and a first moving board 324. The first moving board 324 may include a third sub-board 3242.

A plurality of first moving strips 326 and a plurality of second moving strips 328 may be formed on the third sub-board 3242. In other words, all moving strips of the plurality of first moving strips 326 and the plurality of second moving strips 328 may be disposed on one sub-board 3242.

The third sub-board 3242 may be seated into the receiving groove 3222 formed on one surface of the first moving body 322. Here, four leaf springs 360 may be first seated into the receiving groove 3222, and then the third sub-board 3242 may be seated.

Since each receiving groove 3222 accommodates four leaf springs 360 and one sub-board 3242, the sub-board 3242 may be pressed by the four leaf springs 360.

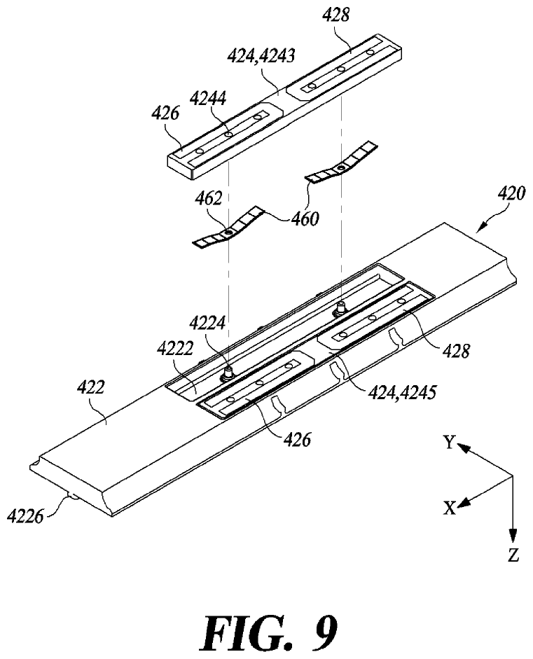

FIG. 9 is a perspective view of a first moving unit 420 according to a fourth embodiment of the present disclosure.

Referring to FIG. 9, the first moving unit 420 may include a first moving body 422 and a first moving board 424.

The first moving board 424 may include a fourth sub-board 4243 and a fifth sub-board 4245 separated from the fourth sub-board 4243 in the second direction.

One first moving strip 426 among a plurality of first moving strips 426 and one second moving strip 428 among a plurality of second moving strips 428 may be formed on the fourth sub-board 4243.

Another first moving strip 426 among a plurality of first moving strips 426 and another second moving strip 428 among a plurality of second moving strips 428 may be formed on the fifth sub-board 4245.

In other words, a plurality of moving strips constituting one strip column may be disposed on one sub-board 4243, 4245.

Each sub-board 4243, 4245 may be seated into the receiving groove 4222 formed on one surface of the first moving body 422. Here, two leaf springs 460 may be first seated into the receiving groove 4222, and then each sub-board 4243, 4245 may be seated.

Since each receiving groove 4222 accommodates two leaf springs 460 and one sub-board 4243, 4245, each sub-board 4243, 4245 may be pressed by the corresponding two leaf springs 460.

As shown in FIGS. 7 to 9, when a plurality of moving strips are formed on one sub-board, the size of the moving board may be reduced, and at the same time, the manufacturing process of the moving board may be simplified further.

Although FIGS. 7 to 9 illustrate the first moving unit as an example, the above description is not limited only to the first moving unit. Accordingly, the description given with reference to FIGS. 7 to 9 may also be applied to the second moving unit without modification.

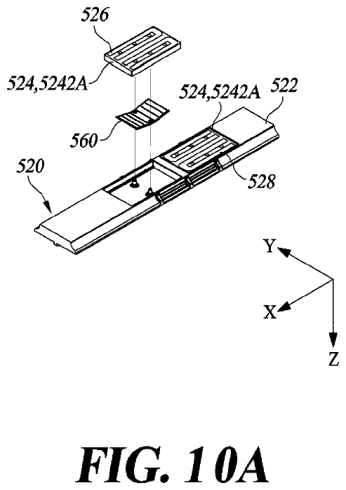

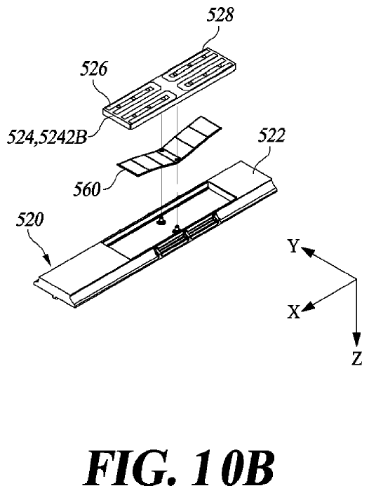

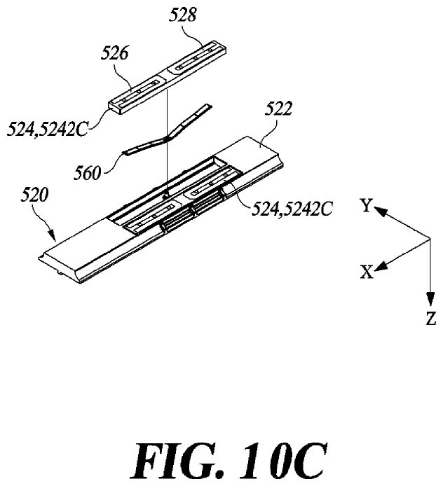

The fifth embodiment of the present disclosure shown in FIG. 10 to be described later differs from the second to fourth embodiments of the present disclosure shown in FIGS. 7 to 9 in that a sub-board is pressed using a relatively smaller number of leaf springs. In what follows, distinctive characteristics of the fifth embodiment of the present disclosure will be mainly described, and repeated descriptions of substantially the same configuration as described above will be omitted.

FIGS. 10A, 10B and 10C are perspective views of a first moving unit 520 according to a fifth embodiment of the present disclosure.

Referring to FIGS. 10A to 10C, the first moving unit 520 may include a first moving body 522 and a first moving board 524.

The first moving board 524 may include a sub-board 5242.

At least two moving strips among a plurality of first moving strips 526 and a plurality of second moving strips 528 may be formed on the sub-board 5242. In other words, a plurality of moving strips may be formed on one sub-board 5242.

The sub-board 5242 according to the fifth embodiment of the present disclosure is configured to be pressed by a smaller number of leaf springs 560 compared to the embodiments illustrated in FIGS. 7 to 9.

Specifically, referring to FIGS. 10A to 10C, the sub-board 5242A, 5242C pressed by two leaf springs in the examples of FIGS. 7 and 9 may be pressed by one leaf spring 560.

Also, referring to FIG. 10B, the sub-board 5242B pressed by four leaf springs in the example of FIG. 8 may be pressed by two leaf springs 560.

When one sub-board 5242 is pressed by a smaller number of leaf springs, the number of leaf springs required to manufacture one phase shifter may be reduced. As a result, the cost of manufacturing a phase shifter may be reduced, and the process of manufacturing a phase shifter may be further simplified.

Although FIGS. 10A, 10B and 10C illustrate the first moving unit as an example, the above description is not limited only to the first moving unit. Accordingly, the description given with reference to FIGS. 10A, 10B and 10C may also be applied to the second moving unit without modification.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

1. A phase shifter comprising:
a fixed unit including a base and a first fixed board disposed on one surface of the base;
a first moving unit movable along a first direction on one surface of the first fixed board, the first moving unit including a first moving board facing the first fixed board; and
a guide bracket fixed to one side of the fixed unit, the guide bracket configured to guide movement of the first moving unit along a first direction,
wherein the first moving board includes a plurality of first moving strips disposed side by side along a second direction perpendicular to the first direction.

2. The phase shifter of claim 1, wherein the first moving board further includes a plurality of second moving strips disposed side by side along the second direction, and
the plurality of first moving strips and the plurality of second moving strips are disposed side by side along the first direction.

3. The phase shifter of claim 2, wherein each first moving strip of the plurality of first moving strips has a convex shape toward a neighboring second moving strip, and
each second moving strip of the plurality of second moving strips has a convex shape toward a neighboring first moving strip.

4. The phase shifter of claim 3, wherein the first moving board does not include different moving strips other than the plurality of first moving strips and the plurality of second moving strips.

5. The phase shifter of claim 2, wherein the first moving board includes a plurality of sub-boards, and
each moving strip of the plurality of first moving strips and the plurality of second moving strips is formed on each sub-board of the plurality of sub-boards.

6. The phase shifter of claim 2, wherein the first moving board includes a first sub-board and a second sub-board separated from the first sub-board in a first direction,
the plurality of first moving strips are formed on the first sub-board, and
the plurality of second moving strips are formed on the second sub-board.

7. The phase shifter of claim 2, wherein the first moving board includes a third sub-board, and
the plurality of first moving strips and the plurality of second moving strips are formed on the third sub-board.

8. The phase shifter of claim 2, wherein the first moving board includes a fourth sub-board and a fifth sub-board separated from the fourth sub-board in a second direction,
one first moving strip among the plurality of first moving strips and one second moving strip among the plurality of second moving strips are formed on the fourth sub-board, and
another first moving strip among the plurality of first moving strips and another second moving strip among the plurality of second moving strips are formed on the fifth sub-board.

9. The phase shifter of claim 2, further comprising a leaf spring disposed on one side of the first moving unit,
wherein the first moving board includes a sub-board,
the leaf spring is configured to press the sub-board toward the first fixed board, and
at least two moving strips among the plurality of first moving strips and the plurality of second moving strips are formed on the sub-board.

10. The phase shifter of claim 4, further comprising a second moving unit movable along the first direction on one surface of a second fixed board, the second moving unit including a second moving board facing the second fixed board,
wherein the second moving board includes a plurality of third moving strips disposed side by side along the second direction and a plurality of fourth moving strips disposed side by side along the second direction, and
the plurality of third moving strips and the plurality of fourth moving strips are disposed side by side along the first direction.

11. The phase shifter of claim 10, wherein each third moving strip of the plurality of third moving strips has a convex shape toward a neighboring fourth moving strip, and
each fourth moving strip of the plurality of fourth moving strips has a convex shape toward a neighboring third moving strip.

12. The phase shifter of claim 11, wherein the second moving board does not include different moving strips other than the plurality of third moving strips and the plurality of fourth moving strips.

13. The phase shifter of claim 10, wherein the guide bracket is configured to guide movement of the first moving unit along a first direction and movement of the second moving unit along the first direction, respectively.
